(19) United States
(12) Patent Application Publication
(10) Pub. No.: US 2012/0254715 A1
(43) Pub. Date: Oct. 4, 2012

(54) VISUALIZER AND EDITOR FOR SINGLE MOLECULE ANALYSIS

(76) Inventors: David Charles Schwartz, Madison, WI (US); Jessica Severin, Cambridge (GB)

(21) Appl. No.: 12/698,224

(22) Filed: Feb. 2, 2010

Related U.S. Application Data
(63) Continuation of application No. 12/620,146, filed on Nov. 17, 2009, now abandoned.
Application No. 12/620,146 is a continuation of application No. 10/888,516, filed on Jul. 12, 2004, now abandoned.
(60) Provisional application No. 60/485,715, filed on Jul. 10, 2003.

(51) Int. Cl. G06F 3/048; G06F 17/00; G06F 17/30

(52) U.S. Cl. 715/230; 707/705; 715/800; 715/780; 715/733; 707/E17.005

(57) ABSTRACT

There is provided a computer system for visualizing and editing single molecule fragments and one or more previously-produced single molecule assemblies or “contigs.” The present visualization and editing system allows a user to visualize large data sets resulting from single molecule map assembly operations, and to rapidly discern important features while errors and other discrepancies are conveniently resolved. The system includes one or more connectors connecting each to one or more databases capable of storing a diverse array of biomedical information, in addition to the single molecule data against which a user may validate the prior alignment and assembly. Embodiments described herein are thus useful in studies of macromolecules such as DNA, RNA, peptides and proteins. The visualization and editing system may be implemented and deployed over a computer network, and may be ergonomically optimized to facilitate user interaction.

### CROSS-REFERENCE INFORMATION

This application claims priority to U.S. Non-Provisional application Ser. No. 12/620,146 filed on Nov. 17, 2009 which is a continuation of U.S. Non-Provisional application Ser. No. 10/888,516 filed on Jul. 12, 2004 which claims priority to 60/485,715 filed Jul. 10, 2003, each of which is hereby incorporated by reference.

### STATEMENT REGARDING FEDERALLY SPONSORED RESEARCH OR DEVELOPMENT

The work described herein in this disclosure was conducted with United States Government support awarded by the Department of Energy, number DE-FG02-99ER62830. The United States Government has certain rights in the invention(s) of this disclosure.

### FIELD

The present disclosure relates to a computer system for visualization and editing of optically imaged single molecules or single molecule assemblies for validation. The unique features of the visualization system embodied in the present disclosure enables the user to visualize and edit large data sets resulting from single molecule map assembly operations and to rapidly discern important features. Errors and other discrepancies are conveniently resolved by way of accessing one or more databases. These databases contain a diverse array of biomedical information in addition to the single molecule data against which a user may validate the prior alignment and assembly. Embodiments described herein are thus useful in studies of any macromolecules such as DNA, RNA, peptides and proteins.

### BACKGROUND

Modern biology, particularly molecular biology, has focused itself in large part on understanding the structure, function, and interactions of essential macromolecules in living organisms such as nucleic acids and proteins. For decades, researchers have developed effective techniques, experimental protocols, and in vitro, in vivo, or in situ models to study these molecules. Knowledge has been accumulating relating to the physical and chemical traits of proteins and nucleic acids, their primary, secondary, and tertiary structures, their roles in various biochemical reactions or metabolic and regulatory pathways, the antagonistic or synergistic interactions among them, and the on and off controls as well as up and down regulations placed upon them in the intercellular environment. The advance in new technologies and the emergence of interdisciplinary sciences in recent years offer new approaches and additional tools for researchers to uncover unknowns in the mechanisms of nucleic acid and protein functions.

The evolving fields of genomics and proteomics are only two examples of such new fields that provide insight into the studies of biomolecules such as DNA, RNA and protein. New technology platforms such as DNA microarrays and protein chips and new modeling paradigms such as computer simulations also promise to be effective in elucidating protein, DNA and RNA characteristics and functions. Single molecule optical mapping is another such effective approach for close and direct analysis of single molecules. See, U.S. Pat. No. 6,294,136, the disclosure of which is fully incorporated herein by reference. The data generated from these studies—e.g., by manipulating and observing single molecules—constitutes single molecule data. The single molecule data thus comprise, among other things, single molecule images, physical characteristics such as the length, shape and sequence, and restriction maps of single molecules. Single molecule data provide new insights into the structure and function of genomes and their constitutive functional units.

Images of single molecules represent a primary part of single molecule datasets. These images are rich with information regarding the identity and structure of biological matter at the single molecule level. It is however a challenge to devise practical ways to extract meaningful data from large datasets of molecular images. Bulk samples have conventionally been analyzed by simple averaging, dispensing with rigorous statistical analysis. However, proper statistical analysis, necessary for the accurate assessment of physical, chemical and biochemical quantities, requires larger datasets, and it has remained intrinsically difficult to generate these datasets in single molecule studies due to image analysis and tile management issues. To fully benefit from the usefulness of the single molecule data in studying nucleic acids and proteins, it is essential to meaningfully process these images and derive quality image data.

Effective methods and systems arc thus needed to accurately extract information from molecules and their structures using image data. For example, a large number of images may be acquired in the course of a typical optical mapping experiment. To extract useful knowledge from these images, effective systems are needed for researchers to evaluate the images, to characterize DNA molecules of interest, to assemble, where appropriate, the selected fragments thereby generating longer fragments or intact DNA molecules, and to validate the assemblies against established data for the molecule of interest. This is particularly relevant in the context of building genome-wide maps by optical mapping, as demonstrated with the ˜25 Mb P. falciparum genome (Lai et. al., Nature Genetics 23:309-313, 1999).

The P. falciparum DNA, consisting of 14 chromosomes ranging in size from 0.6-3.5 Mb, was treated with either NheI or BainHI and mounted on optical mapping surfaces. Lambda bacteriophage DNA was co-mounted and digested in parallel to serve as a sizing standard and to estimate enzyme cutting efficiencies. Images of molecules were collected and restriction fragments marked, and maps of fragments were assembled or “contiged” into a map of the entire genome. Using NheI, 944 molecules were mapped with the average molecule length of 588 Mb, corresponding to 23-fold coverage; 1116 molecules were mapped using BamHI with the average molecule length of 666 Mb, corresponding to 31-fold coverage (Id at FIG. 3). Thus, each single-enzyme optical map was derived from many overlapping fragments from single molecules. Data were assembled into 14 contigs, each one corresponding to a chromosome; the chromosomes were tentatively numbered 1, the smallest, through 14, the largest.

Various strategies were applied to determine the chromosome identity of each contig. Restriction maps of chromosomes 2 and 3 were generated in silico and compared to the optical map; the remaining chromosomes lacked significant sequence information. Chromosomes 1, 4 and 14 were identified based on size. Pulsed field gel-purified chromosomes were used as a substrate for optical mapping, and their maps aligned with a specific contig in the consensus map. Finally, for chromosomes 3, 10 and 13, chromosome-specific YAC clones were used. The resulting maps were aligned with specific contigs in the consensus map (Id at FIG. 4). Thus, in this experiment multi-enzyme maps were generated by first constructing single enzyme maps which were then oriented and linked with one another. For a number of chromosomes that are similar in size, such as chromosomes 5-9, there are many possible orientations_{—} of the maps. Such maps may be linked together by a series of double digestions, by the use of available sequence information, by mapping of YACs which are located at one end of the chromosome, or by Southern blotting.

In short, optical mapping is powerful tool used to construct genome-wide maps. The data generated as such by optical mapping may be used subsequently in other analyses related to the molecules of interest, for example, the construction of restriction maps and the validation of DNA sequence data. There is accordingly a need for systems for visualizing, annotating, aligning and assembling single molecule fragments. Such systems should enable a user to effectively process single molecule images thereby generating useful single molecule data; such systems should also enable the user to validate the resulting data in light of the established knowledge related to the molecules of interest. Robustness in handling large image datasets is desired, as is rapid user response.

This visualization and editing system of the present disclosure is based loosely on the user interface first developed in the Consed viewer and editor for sequence alignment. The software tool, ConVex (Contig Visualization and Exploration tool) was developed as a multi-scale, zoomable interface for visualization and exploration of large high-resolution contiged restriction maps; however, it has evolved into a tool for integrating restriction map assemblies and anchoring sequence reads, now entitled VALIS (see http://galt.mrl.nyu.edu/valis/). ConVex allowed users to visually interact and edit single molecule assemblies and fragments, similar to what Consed allows users to do with sequence data. The visualization and editing system described herein improves upon and expands the capabilities of these programs in terms of speed and functionality, with color coding for error analysis, and better integration with both primary optical mapping image data and other biomedical databases.

### SUMMARY

It is therefore an object of this disclosure to provide a computer system for visualization and editing of data generated from optically imaging single molecules or single molecule assemblies for validation. Particularly in the case of nucleic acid molecules, certain embodiments of the visualization and editing system described herein allow a user to display single nucleic acid molecules or their assemblies. One or more connectors are included in the visualization and editing system allowing connection with one or more databases capable of storing both single molecule and other biomedical data. Such diverse an-ay of data can be retrieved and used to validate the previously-produced assembly of single molecule fragments. The visualization and editing system may he implemented and deployed over a computer network. It may be ergonomically optimized to facilitate user interactions.

In accordance with this disclosure, there is provided, in another embodiment, a computer system for visualizing and editing single molecule fragments, wherein the single molecule images comprise signals derived from individual molecules or individual molecular assemblies or polymers, which system comprises: a connector connecting to a database comprising data from single molecule images; and a user interface capable or displaying single molecule assemblies for visualization and minimal editing, wherein the single molecule assemblies represent longer single molecule fragments.

According to another embodiment, the signals are optical, atomic or electronic. According to another embodiment, the signals are generated by atomic force microscopy, scan tunneling microscopy, flow cytometry, optical mapping or near field microscopy.

According to another embodiment, the single molecule images are derived from optical mapping of single molecules, the single molecules are individual molecules or individual molecular assemblies or polymers. According to yet another embodiment, the single molecules are selected from the group consisting of (i) nucleic acid molecules and (ii) protein or peptide molecules.

According to another embodiment, the single molecule data stored in the database comprises one or more single molecule images. According to another embodiment, the single molecule data further comprises one or more restriction maps. According to yet another embodiment, the single molecule data further comprises one or more sequences. According to still another embodiment, the sequences are nucleotide sequences or amino acid sequences.

According to another embodiment, the database in the visualization and editing system is further capable of storing other biomedical data, wherein the other biomedical data is derived from one or more biomedical technology platforms. According to yet another embodiment, the database comprises one or more data files. According to still another embodiment, the database is a relational database. According to a further embodiment, the database is an object database.

According to another embodiment, the visualization and editing system further comprises one or more additional connectors, each connecting to an additional database. According to yet another embodiment, the one or more additional databases are external databases capable of storing other biomedical data, wherein the other biomedical data is derived from one or more biomedical technology platforms. According to still another embodiment, the one or more additional databases are capable of storing single molecule data. In another embodiment, the single molecule data comprises one or more single molecule images. In yet another embodiment, the single molecule data further comprises one or more restriction maps. In still another embodiment, the single molecule data further comprises one or more sequences. In a further embodiment, the sequences are nucleotide or amino acid sequences.

According to still another embodiment, the additional database having stored therein single molecule data is also capable of storing other biomedical data, wherein the other biomedical data is derived from one or more biomedical technology platforms.

According to another embodiment, the single molecule visualization and editing system is implemented and deployed over a computer network. According to another embodiment, the user interface in the visualization and editing system further allows a user to retrieve single molecule data from the database or one or more additional databases and validate the single molecule assemblies against the single molecule data. According to yet another embodiment, the user interface further allows a user to retrieve other biomedical data from the one or more external databases and validate the single molecule assemblies against the other biomedical data.

According to another embodiment, the single molecule visualization and editing system is ergonomically optimized. According to yet another embodiment, the user interface displays the single molecule fragments or assemblies with horizontal scaling. According to still another embodiment, the user interface displays the single molecule fragments or assemblies with vertical scaling. According to a further embodiment, the user interface displays the single molecule fragments or assemblies with color coding.

### BRIEF DESCRIPTION OF DRAWINGS

FIG. 1 is a screenshot of the user interface of the computer system for visualizing and editing single molecule fragments and their assemblies according to one embodiment of this disclosure. It shows the prior alignment and assembly of a set of single DNA molecule fragments along with alignment to a computer-generated restriction map of sequence. This sequence map is used to reference the assembly to information in other biomedical databases, represented by the data rows with SNP and Repeat Masker data (see “Chr6 SNP” and “Chr6 rmsk LINE”).

### DETAILED DESCRIPTION

### Brief Discussion Of Relevant Terms

The following disciplines, molecular biology, microbiology, immunology, virology, pharmaceutical chemistry, medicine, histology, anatomy, pathology, genetics, ecology, computer sciences, statistics, mathematics, chemistry, physics, material sciences and artificial intelligence, are to be understood consistently with their typical meanings established in the relevant art.

As used herein, genomics refers to studies of nucleic acid sequences and applications of such studies in biology and medicine; proteomics refers to studies of protein sequences, conformation, structure, protein physical and chemical properties, and applications of such studies in biology and medicine.

The following terms: proteins, nucleic acids, DNA, RNA, genes, macromolecules, restriction enzymes, restriction maps, physical mapping, optical mapping, optical maps (restriction maps derived from optical mapping), hybridization, sequencing, sequence homology, expressed sequence tags (ESTs), single nucleotide polymorphism (SNP), CpG islands, GC content, chromosome banding, and clustering, are to he understood consistently with their commonly accepted meaning in the relevant art, i.e., the art of molecular biology, genomics, and proteomics.

As used herein, the terms “visualization system,” “visualization and editing system,” and “single molecule assembly visualization and editing system,” may be used interchangeably in various embodiments of this disclosure, and refer to the computer system disclosed herein that allows a user to display representations of imaged single molecule fragments or assemblies, to minimally edit these previously generated assemblies, and to validate them by visual comparison with corresponding data contained in one or more connected (single molecule or other biomedical) databases.

The following terms, atomic force microscopy (AFM), scan tunneling microscopy (STM), flow cytometry, optical mapping, and near field microscopy, etc., are to be understood consistently with their commonly accepted meanings in the relevant art, i.e., the art of physics, biology, material sciences, and surface sciences.

The following terms. “database,” “database server,” “data warehouse,” “operating system,” “application program interface (API),” “programming languages,” “C,” “C++,” “Extensible Markup Language (ML),” “SQL,” as used herein, are to be understood consistently with their commonly accepted meanings in the relevant art, i.e., the art of computer sciences and information management. Specifically, a database in various embodiments of this disclosure may be flat data files and/or structured database management systems such as relational databases and object databases. Such a database thus may comprise simple textual, tabular data included in flat files as well as complex data structures stored in comprehensive database systems. Single molecule data may be represented both in flat data files and as complex data structures.

As used herein, the terms “edit” or “editing” refer to the function provided by the visualization system of this disclosure to remove maps or sequences that contain a high number of errors for reprocessing in an external assembly system. These terms also refer to deletion of restriction cuts and merging of consensus fragment masses.

As used herein, single molecules refer to any individual molecules, such as macromolecule nucleic acids and proteins. A single molecule according to this disclosure may be an individual molecule or individual molecular assembly or polymer. That is, for example, a single peptide molecule comprises many individual amino acids. Thus, the terms “single molecule,” “individual molecule,” “individual molecular assembly,” and “individual molecular polymer” are used interchangeably in various embodiments of this disclosure. Single molecule data refers to any data about or relevant to single molecules or individual molecules. Such data may be derived from studying single molecules using a variety of technology platforms, e.g., flow cytometry and optical mapping. The single molecule data thus comprise, among other things, single molecule images, physical characteristics such as length, height, dimensionalities, charge densities, conductivity, capacitance, resistance of single molecules, sequences of single molecules, structures of single molecules, and restriction maps of single molecules. Single molecule images according to various embodiments comprise signals derived from single molecules, individual molecules, or individual molecule assemblies and polymers; such signals may be optical, atomic, or electronic, among other things. For example, a single molecule image may be generated by, inter alia, atomic force microscopy (AFM), flow cytometry, optical mapping, and near field microscopy. Thus, electronic, optical, and atomic probes may be used in producing single molecule images according to various embodiments. In certain embodiments, various wavelengths may be employed when light microscopy is used to generate single molecule images, including, e.g., laser, 1.3V, near, mid, and far infrared. In other embodiments, various fluorophores may be employed when fluorescent signals are acquired. Further, single molecule images according to various embodiments of this disclosure may be multi-spectral and multi-dimensional (e.g., one, two, three-dimensional).

As used herein, “genomics and proteomics data” refers to any data generated in genomics and proteomics studies from different technology platforms; and biomedical data refers to data derived from any one or more biomedical technology platforms.

As used herein, the term “contig” refers to a nucleotide (e.g., DNA) whose sequence is derived by clustering and assembling a collection of smaller nucleotide (e.g., DNA) sequences that share certain level of sequence homology. Typically, one manages to obtain a full-length DNA sequence by building longer and longer contigs from known sequences of smaller DNA (or RNA) fragments (such as expressed sequence tags, ESTs) by performing clustering and assembly.

As used herein, the term “single molecule assembly” refers to larger single molecule fragments assembled from smaller fragments. In the context of nucleic acid single molecules, “assembly” and “contig” are used interchangeably in this disclosure.

The term “array” or “microarray” refers to nucleotide or protein arrays; “array,” “slide,” and “chip” are interchangeable where used in this disclosure. Various kinds of nucleotide arrays are made in research and manufacturing facilities worldwide, some of which are available commercially. (e.g., GeneChip™ by Affymetrix, Inc., LifeArray™ by Incyte Genomics}. Protein chips are also widely used. (See Zhu et al., Science 293(5537):2101-05, 2001).

The terms, “user interface,” and “viewer,” as used herein may be used interchangeably, and refer to any kind of computer-application or program that enables interactions with a user. A user interface or viewer may be a graphical user interface (GUI). Examples of GUIs include Microsoft Internet Explorer™ and Netscape Navigator™ Adobe Illustrator, Adobe Photoshop, Adobe Acrobat, Microsoft Powerpoint, Microsoft Excel, CricketGraph, Corel Draw, Ximian Evolution, and StarOffice. A user interface also may be a simple command line interface in alternative embodiments. A user interface of the invention(s) of this disclosure may also include plug-in tools that extend the existing applications and support interaction with standard desktop applications. A user interface in certain embodiments of the invention(s) of this disclosure may be designed to best support users' browsing activities according to ergonomic principles.

“Ergonomically optimized,” as used herein, refers to optimization on the design and implementation of the visualization and editing system based on ergonomics principles. The International Ergonomics Association (http://www.iea.cc/) defines ergonomics as both the scientific discipline concerned with the understanding of interactions among humans and other elements of a system, as well as the profession that applies theory, principles, data and methods to design in order to optimize human well-being and overall system performance. Ergonomists contribute to the design and evaluation of tasks, jobs, products, environments and systems to make them compatible with a user's needs, abilities and limitations. Ergonomically optimized systems according to this disclosure provide reduced error rate and improved efficiency and quality in user interaction.

### Visualization and Validation System For Single Molecule Analysis

The computer visualization and editing system according to this disclosure provides an application framework designed to allow the development of genome level alignment visualization and validation of single molecule fragments or their previously-generated assemblies, with minimal editing functionalities. The primary goal of the design is to provide a database solution that allows for fast “multi-tracked” display of single molecule optical map data along side external genomic data such as genes, sequence coverage, STS markers, SNP sites, CpG islands, chromosome banding, GC content, chromosome banding, amino acid sequences of the encoded proteins, primary and tertiary structures of the encoded proteins, and molecules or agents that potentially interact with the DNA molecules or the encoded proteins, and other data collected from one or more external databases as indicated further infra. The system disclosed herein thus allows visual validation of the success of the external contig assembly process through internal consistencies and error color coding discussed infra. Potential discrepancies, ambiguities or errors in the optical map assemblies or sequences can be identified. The system disclosed herein may also assist in detection of a veritable difference in sequence between individuals, strains or organisms.

The database to which the system according to this disclosure is connected may be a flat file, a relational database, an object database or a data warehouse in various embodiments according to this disclosure. A suitable relational database server for the system is, e.g., MySQL (see, http://www.mvsql.com/). Other examples of object databases that may be used include JYD Object Database (see, http://www.jyd.com/), db4o (see, http://www.db4o.com/), and Objectivity/DB (by Objectivity Inc.). The database in another embodiment may be a data warehouse or a distributed database deployed over a network. The visualization and editing system according to this disclosure thus may be implemented and deployed over a computer network.

In alternative embodiments, the visualization and editing system may include additional connectors that link the system to additional databases. These additional databases may also store information on single molecules and other biomedical information. These databases may be external databases such as those accessible over the Internet, e.g., GENBANK (http://www.ncbi.nlm.nih.gov/entrez/query.fegi?db=Nuelcotide), SWIS-PROT (www.expasy.ch/sprot/), GeneCards™ (http://bioinfo.weizmann.ac.il/cards/index.html), OMIM (http://www.ncbi.rilm.niltypv/entrez/query.fcgi?db=OMIM), and the NCBI SNP Database (http://www.ncbi.nlm.nih.gov/SNP/). The computer visualization and editing system according to certain embodiments of this disclosure thus allows visualization and editing of restriction maps as well as validation of these maps with the fragment sequence data, the latter being retrievable from the connected databases. The representation of restriction maps and contigs in the computer visualization and editing system is compatible with that in the database connected thereto and therefore the single molecule data in the database may be updated as new assemblies are generated externally.

Example 1 infra shows a number of procedures that enable the connection to a database and access to the information therein according to one embodiment of this disclosure. Once constructed, the longer fragments or assemblies may then be uploaded to the database storing the single molecule data on the fragments of interest.

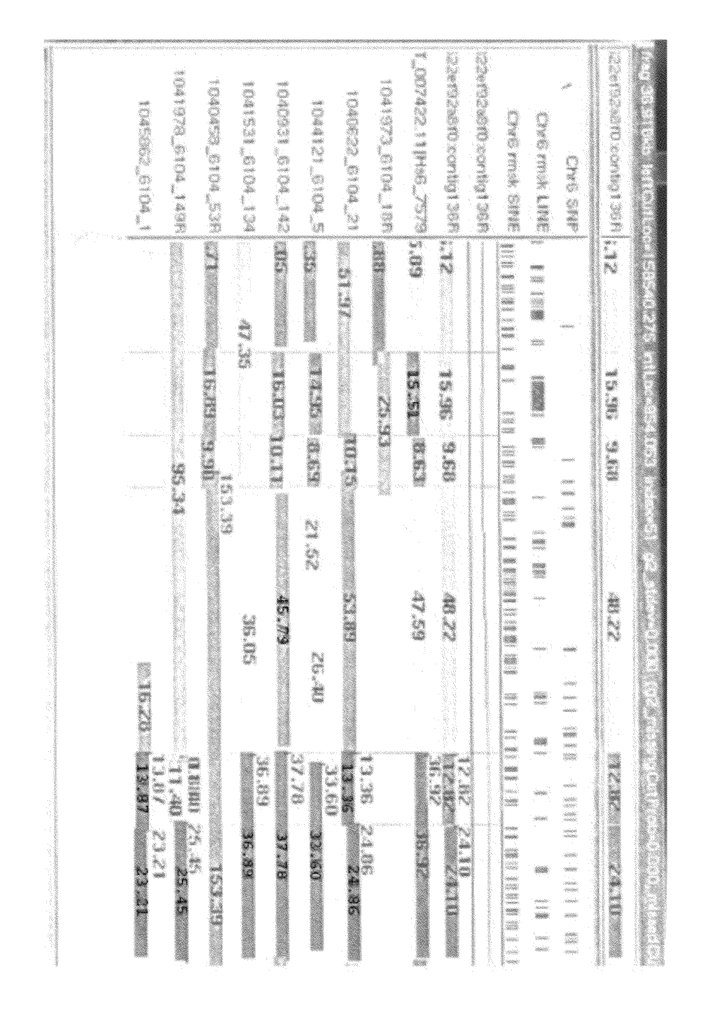

The computer visualization and editing system provides a user interface that is capable of displaying single molecule fragments. A user may view the prior alignment and assembly of single molecules or fragments and, if necessary, minimally edit these data by removing, from contig assemblies by simple selection and keystroke of the delete key, whole maps with a high degree of error. This process allows updating of the external contig assembly process for generation of more accurate output. The user may also delete restriction cuts and merge consensus fragments within the system of the present disclosure. Example 2 infra includes a procedure implemented in C++ for the graphical user interface to visualize, edit and manipulate the visualization of a contig. FIG. 1 shows a screenshot of the user interface for the computer visualization system according to one embodiment of this disclosure. The fragments of optical maps depicted in the multiple rows are aligned with respect to common cut sites, thus representing areas of potential overlap among fragments. The computer visualization and editing system in certain embodiments employs color coding in the user interface for the visual presentation of externally-generated single molecule fragment alignment and assembly. It is useful for error analysis and validation of the assemblies or contigs being constructed. In other embodiments, horizontal and vertical scaling is employed in the user interface to aid visualization of the alignment and assembly. In one embodiment, infinite horizontal scaling is implemented. In another embodiment, discrete vertical scaling is implemented.

Example 3 infra provides C++ code implementing procedures for the graphical user interface to visualize and manipulate the visualization of external genetic annotation, obtained through other methods from databases such as NCBI, for example. Example 4 infra presents a C++ code file showing implementation of an object that manages multiple aligned views within the GUI. These views may relate to multiple contigs of optical maps or multiple annotation tracks or mixtures of contigs, and annotation tracks.

The computer visualization and editing system according to this disclosure is ergonomically optimized. Established ergonomic principles may be followed as discussed supra. This optimization reduces user response time and increases the overall system efficiency in processing large datasets.

According to this disclosure, the computer visualization and editing system in various embodiments may be implemented in different programming languages, including, e.g., C, C—H— used in Examples 1-4 and any other comparable languages.

Additional embodiments of this disclosure are further described by the following examples, which are only illustrative of the embodiments but do not limit the underlining invention(s) in this disclosure in any manner.

It is to be understood that the description, specific examples and data, while indicating exemplary embodiments, are given by way of illustration and are not intended to limit the present invention(s) in this disclosure. All references cited herein for any reason, are specifically and entirely incorporated by reference. Various changes and modifications which will become apparent to a skilled artisan from this disclosure are considered part of the invention(s) of this disclosure.

As used herein and in the following claims, articles such as “a,” “an,” “the” and the like can mean one or more than one, and are not intended in any way to limit the terms that follow to their singular form, unless expressly noted otherwise. Unless otherwise indicated, any claim which contains the word “or” to indicate alternatives shall be satisfied if one, more than one, or all of the alternatives denoted by the word “or” are present in an embodiment which otherwise meets the limitations of such claim.

1. A computer system for validating single molecule assemblies, the computer system comprising:
(a) a first database comprising single molecule data, the single molecule data comprising image data derived from optical mapping of a single molecule assembly;
(b) a second database comprising biomedical data associated with the single molecule assembly;
(c) a first database connector communicatively linked to the first database, and a second database connector communicatively linked to the second database;
(d) a user interface programmatically linked to the first database connector and the second database connector, the user interface displaying the single molecule data from the first database and the biomedical data from the second database, the user interface programmed to display the single molecule data alongside the biomedical data, to provide horizontal and vertical scaling of the single molecule image data, to receive user input commands for interacting with the single molecule data and biomedical data, and to delete the single molecule data from the first database upon receipt of a command from the user input device; and
(e) a user input device communicatively linked to the user interface, the user input device transmitting at least one user input command for interacting with the single molecule data.

2. The computer system of claim 1, wherein the single molecule assembly comprising a first single molecule fragment and a second molecule fragment, the first database associating the single molecule data of the single molecule fragment with the single molecule data of the second molecule fragment.

3. The computer system of claim 2, wherein the user interface further programmed to display the first molecule data in a first row and the second molecule data in a second row, the first row and the second row being proximately located on the user interface.

4. The computer system of claim 3, wherein the user interface further programmed to differentiate the first molecule data from the second molecule data using a color code.

5. The computer system of claim 2, wherein the user interface further programmed to merge the first single molecule fragment with the second molecule fragment as a merged molecule data and to store the merged molecule data in the first database upon receipt of a command from the user input device.

6. (canceled)

7. The computer system of claim 1, wherein the single molecule data further comprising at least one restriction map.

8. The computer system of claim 1, further comprising a computer network and at least one database server, wherein the first database connector and the second database connector are communicatively linked to the first database and second database by the computer network, and the first database and the second database being stored on at least one database server.

9. The computer system of claim 1, wherein the biomedical data is genomic data, and wherein the single molecule assemblies are DNA molecules.

10. The computer system of claim 1, wherein the biomedical data is proteomics data, and wherein the single molecule assemblies are protein molecules.

11. The computer system of claim 1, wherein the user interface is a graphical user interface, the graphical user interface being programmed to display a window for displaying the single molecule data alongside the biomedical data.

12. The computer system of claim 11, wherein the user interface is further programmed to differentiate single molecule data from the biomedical data using color coding.

13. The computer system of claim 1, further comprising a software application, wherein the user interface is implemented as a plug-in for the software application.

14. The computer system of claim 1, wherein the user interface further programmed to include a command line for receiving user input commands.

15. The computer system of claim 1, further comprising a third database and a third database connector communicatively linked to the third database, the third database comprising genetic annotation data associated with the single molecule data; and
wherein the user interface further programmed to display the genetic annotation data.

16. The computer system of claim 15, wherein the genetic annotation data is displayed along side the single molecule data and the biomedical data.

17. The computer system of claim 1, wherein the biomedical data is selected from the group consisting of: genes, sequence coverage, sequence tagged side (STS) markers, single-nucleotide polymorphism (SNP) sites, CpG islands, chromosome banding, guanine-cytosine (GC) content, chromosome banding, amino acid sequences of the encoded proteins, primary and tertiary structures of encoded proteins, and molecules or agents that potentially interact with DNA molecules or encoded proteins.

18. The computer system of claim 1, further comprising a computer network and at least one database server, wherein the second database connector is communicatively linked to the second database by the computer network, and the second database is stored on the least one database server.

19. The computer system of claim 8 or 18, wherein the computer network is the internet.

20. The computer system of claim 8 or 18, wherein the computer network is a local area network.

21. The computer system of claim 1, wherein the first database and second database are relational databases.

22. The computer system of claim 1, wherein the first database and second database are object databases.
